(19) United States
(12) Patent Application Publication
(10) Pub. No.: US 2026/0117745 A1
(43) Pub. Date: Apr. 30, 2026

(54) Method of assembling drive train for wind turbine, wind turbine and assembly kit thereof

(71) Applicant: Envision Energy Co., Ltd., WUXI (CN)

(72) Inventors: Ralf Rueschoff, Dortmund (DE); Matthias Walkowiak, Dortmund (DE); Stephane Eisen, Dortmund (DE); Pawel Trzewik, Dortmund (DE); JoergenDitlev Christensen, Dortmund (DE)

(73) Assignee: Envision Energy Co., Ltd., WUXI (CN)

(21) Appl. No.: 19/433,254

(22) Filed: Dec. 26, 2025

Related U.S. Application Data
(63) Continuation of application No. PCT/CN2023/117537, filed on Sep. 7, 2023.

(51) Int. Cl. F03D 13/10; F03D 15/10

(52) U.S. Cl. CPC F03D 13/122; F03D 15/101; F05B 2230/60; F05B 2260/301; F05B 2260/40311

(57) ABSTRACT

The present invention relates to a method of assembling a drivetrain for a wind turbine, and a wind turbine and an assembly kit thereof. First fixture elements are secured to first planet carrier of the first gear stage and second fixture elements are secured to the gearbox housing. The respective gear stages of the gearbox unit are pre-assembled, where the first planet carrier is fixed relative to the gearbox housing via the first and second fixture elements. The first ring gear is further fixed relative to the gearbox housing by fastener elements. The pre-assembled gearbox unit is then aligned with the main shaft and moved into position relative to each other. The gearbox housing is mounted to the main bearing housing, and the first planet carrier is released and moved axially into position relative to the flange of the main shaft.

### CROSS REFERENCE TO RELATED APPLICATION

This application is a continuation of International Application No. PCT/CN2023/117537, filed on Sep. 7, 2023, titled “A method of assembling a drive train for a wind turbine, a wind turbine and an assembly kit thereof”, the entire contents of which are incorporated herein by reference.

### FIELD OF THE INVENTION

The present invention relates to a method of assembling a drivetrain of a wind turbine, the drivetrain comprising a main shaft, a gearbox and a generator, the main shaft is configured to be connected to a rotor hub at one end and to a gearbox input at the opposite end, and the generator further has a gearbox output configured to be connected to a generator rotor. The method comprises the steps of preparing the gearbox for installation, aligning the gearbox with the main shaft, and moving the gearbox into position and securing it to the main shaft.

The present invention also comprises a wind turbine with a drivetrain thereof.

### BACKGROUND OF THE INVENTION

It is known that wind turbines over the recent years have increased in tower height and rotor diameter to capture more energy from the wind, thereby increasing the electrical power capacity of the wind turbine. Thereby increasing the size and weight of the individual components, as the main shaft and main frame must support the increased weight of the rotor. As a result, increased torque and loads are transferred from the main shaft to the gearbox and into the generator. The design of wind turbine drive trains has also evolved towards more integrated drive train arrangements.

During assembly, the main shaft and the gearbox are aligned and moved into position relative to each other. A high tolerance during designing the components is needed. A known problem is that the main shaft and gearbox must be accurately aligned during assembly, such as disclosed in CN 103042378 B. This is difficult to achieved using an overhead crane and is time consuming.

CN 204621527 U discloses an assembly stand for assembling the main shaft and the gearbox, where the main shaft is resting on a first support and the gearbox is resting on a second support. A linear actuator on the first support is used to move the main shaft into position relative to the gearbox. CN103244363 B also discloses an assembly stand for assembling the main shaft and the gearbox, where the main shaft is resting on a first support and the gearbox is resting on a second support. A tensioning device mounted to the opposite end of the gearbox is connected to the main shaft through a central hole in the gearbox.

Both solutions disclose an expansion sleeve that extends around the outer surface of the main shaft and is connected to the input end of the gearbox. The main shaft and gearbox are then locked together by the expansion sleeve. The expansion sleeve requires very precise alignment between the main shaft and gearbox.

EP 3018341 B1 discloses another assembly stand for assembly of the mains shaft and the gearbox, where the main shaft and the gearbox are resting on individual supports and then moved into position. The main shaft and the gearbox are secured by a press-fit or shrink disc coupling. Such couplings are known to fail due to misalignments.

CN 110802380 B discloses an assembly method for planetary gears of a wind turbine gearbox, where the individual gear parts are assembled vertically. No details of how to install the gearbox is provided. CN 113909842 B discloses an alternative assembly method where the gear stages of the gearbox are assembled directly onto the main shaft. The main shaft is positioned vertically, and the gear components are then lowered into position and secured to the main shaft. During synchronous adjustment of the gears, the first gear stage is fixed relative to the main shaft while the second gear stages are fixed relative to the first gear stage. When the adjustment is complete, the fixtures are removed. However, this solution requires the main shaft with gearbox to be removed from the nacelle during maintenance or replacement.

### OBJECT OF THE INVENTION

One object of the present invention is to solve the problems of the abovementioned prior art.

One object of the present invention is to provide a method, wind turbine and assembly kit that reduces the risk of damaging the potential contact surfaces during assembly and allows for a simpler assembly process.

One object of the present invention is to provide a method, wind turbine and assembly kit that is suited for assuming a compact drivetrain.

### DESCRIPTION OF THE INVENTION

One object of the present invention is achieved by a method of assembling a drivetrain of a wind turbine, the drivetrain comprising at least a main shaft unit and a gearbox unit with at least one gear stage, where the method comprises the steps of:
providing a main shaft having a rotor end and a gearbox end,
providing a gearbox having a main shaft end and a generator end,
aligning the main shaft unit and the gearbox unit relative to each other,
moving the main shaft end of the gearbox and the gearbox end of the main shaft into position relative to each other,
connecting the main shaft unit to the gearbox unit,
   wherein when moved into position, a first planet carrier of the gearbox is further moved axially from a retracted position into an extended position, in which the first planet carrier is connected to a flange of the main shaft at the gearbox end.

This provides an improved method of assembling a drivetrain of a wind turbine, comprising at least a main shaft unit and a gearbox unit. The present method reduces the risk of misalignment between the main shaft and the gearbox unit during assembly, as the inputting planet carrier is fixed in a retracted, assembly position and then guided into contact with the main shaft. This present method is suited for the assembly of compact drivetrains, such as integrated drivetrains, in which no bearings are supporting the first planet carrier.

Here, the term “moving into position relative to each other” should be understood as the two units being moved towards each other into an assembly position. This may be achieved by moving only one of the two units or by moving both units.

Initially, the main shaft unit and the gearbox unit are aligned relative to each other in at least the axial or circumference direction, preferably in both the axial and circumference directions. The main shaft unit may be arranged in a stationary position while the gearbox unit may be arranged in a moveable position, or vice versa. Alternatively, both the main shaft unit and the gearbox unit may be arranged in separate moveable positions relative to each other. The present method allows the assembly to be performed either vertically or horizontally.

The planet carrier (ref. first planet carrier) of the first gear stage is placed in a retracted position within the gearbox unit. When in the retracted position, the gearbox unit and the main shaft unit are moved into an assembly position relative to each other. During this movement, a ring gear (ref. first ring gear) of the first gear stage may be moved into contact with a main bearing housing. Thereby, a local bearing housing end of the ring gear may contact a local gearbox end of the main bearing housing. Optionally, the gearbox end of the main bearing housing may comprise a recess shaped to guide the ring gear end of the ring gear into position. Further, a local main shaft end of the first planet carrier may be guided into a recess at a local gearbox end of the main shaft. This allows the main shaft and gearbox to be guided into position during assembly.

In one embodiment, the first planet carrier is fixed relative to another gearbox part, preferably a gearbox housing, prior to moving the gearbox unit and the main shaft unit into position.

In the retracted position, the first planet carrier may be secured to another part of the gearbox unit. Preferably, the other gearbox part may be the gearbox housing. Optionally, the first planet carrier may be rotated into an angular position and then fixed relative to the other gearbox part in an assembly position. The first planet carrier may thus be fixed in the gearbox to restrict its movement during alignment. This also allows for an easier alignment of the respective the flange and first planet carrier.

In one embodiment, the first planet carrier is fixed to the other gearbox part by mounting a number of temporary fixtures to the first planet carrier and to the other gearbox part.

The first planet carrier may be secured by using one or more temporary fixtures, which may be connected to or arranged between the first planet carrier and the other gearbox part. The number of temporary fixtures, e.g., standardised or custom-made fixtures, may depend on the size and configuration of first gear stage. The fixtures may be mounted before moving the main shaft unit and the gearbox unit into position. The fixtures may be removed during or after connecting the main shaft to the gearbox. This allows the first planet carrier to be fixed in the axial direction and/or the radial direction during assembly.

In one embodiment, at least one first fixture element is mounted to the first planet carrier and at least one second fixture element is mounted to the other gearbox part, where the first planet carrier is fixed relative to the other gearbox part by bringing the first and second fixture elements into engagement to form at least one pair of temporary fixtures.

The fixture may be formed by a single fixture element, e.g., a bracket or wedge, which may be configured to fix the first planet carrier relative to the other gearbox part. Alternatively, the fixture may be formed by a pair of fixture elements, which may be shaped to engage or interact with each other, when mounted. The fixture elements may be formed as a female and a male element, or as a plug and a socket element. This allows for an easy fixture of the first planet carrier.

Preferably, a first fixture element may be mounted to the first planet carrier and a second fixture element may be mounted to the other gearbox part. When brought into engagement, the first and second fixture elements may fix the first planet carrier in the assembly position. For example, the first fixture element may be a rod and the second fixture element may be bushing, as described later. This allows for an easy mounting of each pair of fixture elements on the first planet carrier and the other gearbox part, respectively.

In one embodiment, when moved into position, a gearbox housing of the gearbox is secured to a main bearing housing by first fastener elements.

When positioned, the gearbox housing may be connected to the main bearing housing using one or more fastener elements (ref. first fastener elements). The first fastener elements may be connected to the gearbox housing or the main bearing housing before moving the main shaft unit and the gearbox unit into position. Alternatively, the first fastener elements may be inserted, when the main shaft and gearbox are moved into position, through one of the main bearing and gearbox housings and then connected to the gearbox and main bearing housings respectively. This allows for a secure connection between the main bearing housing and the gearbox housing.

For example, the first fastener elements may be long bolts with a threaded portion at one or both ends. The bolts may be fastened at one or both ends by nuts and/or internal threaded portions.

In one embodiment, second fastener elements are inserted into the flange and at least partly secured to the first planet carrier, where the first planet carrier is moved axially by tightening the second fastener elements.

The flange of the main shaft and a local main shaft end of the first planet carrier may be moved towards each other until the main shaft unit and the gearbox unit are in the assembly position. As the first plant carrier is in the retracted position, a gap is formed between a local end surface of the flange and an opposite local end surface of the first plant carrier. This reduces the risk of damaging the interface between the main shaft and the first planet carrier during assembly.

The main shaft end of the first planet carrier may be guided into engagement with the gearbox end of the main shaft during the movement. This allows the first planet carrier to be guided into position relative to the main shaft during assembly.

One or more fastener elements (ref. second fastener elements) may be loosely connected to the main shaft end of the gearbox. The second fastener elements may be inserted through the flange of the main shaft. The first planet carrier may then be pulled axially towards the flange and into an extended position by tightening the second fastener elements. Further, the second fixture elements may be released relative to the first fixture elements to allow movement of the first planet carrier. This enables the first planet carrier to move axially, thus bringing the end surface of the flange into contact with the opposite end surface of the first planet carrier. Thereby forming a secure connection between the flange and the first planet carrier.

For example, the second fastener elements may be bolts with a threaded portion at one or both ends. The bolts may be fastened at one or both ends by nuts and/or internal threaded portions.

In one embodiment, the method further comprises the step of pre-assembling the respective gear stages of the gearbox in a vertical direction.

The respective gear stages of the gearbox unit may be pre-assembled before the gearbox unit may be aligned with and moved into position relative to the main shaft unit. The pre-assembly of the gear stages may be performed vertically or horizontally depending on the gearbox configuration. This allows the components of the gearbox unit to be pre-assembled under controlled conditions and with minimal loads. For example, the gearbox unit may be assembled using known assembly methods.

If the gearbox unit is pre-assembled horizontally, then the gearbox unit may simple be moved into alignment with the main shaft during assembly. If the gearbox unit is pre-assembled vertically, then the gearbox unit may be turned and then moved into alignment with the main shaft unit during assembly.

In the present method, it is advantageous to pre-assemble the gearbox unit in a vertical position to minimize gravity loads. This allows for an easier fixation of the first planet carrier relative to the other gearbox part in the retract position.

In one embodiment, a first ring gear of the gearbox is fixed relative to the gearbox housing before moving the main shaft end and the gearbox end into position.

A ring gear (ref. first ring gear) of the first gear stage may be slid into position over the first fastener elements before moving the main shaft unit and the gearbox unit into position. Alternatively, the first fastener elements may be inserted after the main shaft unit and the gearbox unit are moved into position, through the first ring gear before being connected to the gearbox and main bearing housings respectively. This allows the ring gear to be fixed in angular position via the first fastener elements.

Preferably, the first fastener elements may be connected to the gearbox housing. The ring gear may then be rotated into the angular position and slid into position over the first fastener elements. Alternatively, the ring gear may be positioned relative to the gearbox housing and the first fastener elements may then be inserted through the ring gear and connected to the gearbox housing. This allows the ring gear to be fixed in a radial direction, thereby allowing for an easier alignment between the gearbox housing and the main bearing housing.

Nuts may be temporary connected to the opposite end of the first fastener elements until the main shaft and the gearbox are aligned. This allows the gearbox components to be held in place during handling.

In one embodiment, the main shaft and the gearbox are assembled and/or disassembled onsite and up-tower, wherein the gearbox is optionally pre-assembled at another location.

The present method allows the abovementioned assembly of the main shaft unit and the gearbox unit to be performed onsite and up-tower. Here, the term “up-tower” should be understood as the assembly being performed while the main shaft and gearbox units are in the nacelle. Here, the term “onsite” should be understood as the assembly being performed at the installation site of the wind turbine. This may save costs as the drivetrain components can be transported separately. This may also save costs as the repair or replacement of the main shaft or gearbox can be performed at the top of the wind turbine tower.

Further, the present method allows the gearbox unit to be pre-assembled offsite and/or down-tower. Here, the term “down-tower” should be understood as the pre-assembly being performed at ground level relative to the wind turbine tower. Here, the term “offsite” should be understood as the pre-assembly being performed at a separate location, such as a factory or an assembly site.

One object of the present invention is achieved by an assembly kit for use in assembling a drivetrain for a wind turbine, comprising:
at least one first fixture element configured to be mounted to a first planet carrier of the gearbox,
at least one second fixture element configured to be mounted to another gearbox part, preferably a gearbox housing,
wherein the first fixture element is shaped to engage the second fixture element to form at least one pair of temporary fixtures for fixing the first planet carrier relative to the other gearbox part.

This provides an assembly kit for use during assembly of a drivetrain of a wind turbine. The assembly kit allows the planet carrier of the first gear stage to be fixed in a retracted position. The assembly kit further allows the first planet carrier to be moved axially into contact with the flange of the main shaft. The present assembly kit can be removed and reused to assemble another main shaft and gearbox, or to assembly other drivetrain configurations.

The assembly kit comprises at least one pair of fixture elements, which are configured to engage with each other to fix a first planet carrier relative to the other gearbox part in the axial direction and/or radial direction. The first fixture element is mounted to or arranged a first planet carrier of the gearbox. The second fixture element is mounted to or arranged the other gearbox part, such as the gearbox housing. The configuration and shape of the first and second fixture elements may be adapted to the configuration of the gearbox. The first and second fixture elements are then removed during or after the connection of the main shaft and the gearbox. For example, the fixture elements may be removed after the bearing housing and the gearbox housing are connected.

In one embodiment, the first fixture element is a rod with a first end and an opposite second end, the first end being configured to be secured to a mounting point on the first planet carrier.

The first fixture element may be shaped to be mounted to the first planet carrier, preferably at a dedicated mounting point. The first fixture element may be a rod and the mounting point may be mounting hole in the first planet carrier. One end of the rod and the corresponding mounting hole may comprise a threaded coupling so the rod may be secure to the planet carrier, when inserted. The first fixture element may be inserted from the exterior of the gearbox housing. This allows for an easy fixing of the first fixture element.

In one embodiment, the second fixture element is a bushing with a hole, a first end and an opposite second end, the second end being configured to be secured to a mounting point on the other gearbox part.

The second fixture element may be shaped to be mounted to the other gearbox part, preferably the gearbox housing, at a dedicated mounting point. The second fixture element may be a bushing and the mounting point may be a mounting hole, or through hole, in the other gearbox part. The mounting points for the first and second fixture elements may be aligned with each other, preferably in the axial direction. Thereby, the first fixture element may engage with the second fixture element to form a pair of fixture elements.

The second fixture element and the corresponding mounting point may comprise a threaded coupling. Alternatively, the second fixture element may be mounted to the other gearbox part at one end using fastener elements, such as bolts or screws. Alternatively or additionally, the second fixture element may be mounted directly to the first fixture element at the other end. This allows for an easy fixing of the second fixture element.

The first planet carrier may rest on, or simply contact, the other end of the second fixture element, when mounted. The local length of the second fixture element may be selected dependent on the nominal axial position of the first planet carrier relative to the other gearbox part. This allowing the first planet carrier to be fixed in a pre-determined retracted axial position using the second fixture elements.

The second fixture element may be inserted through the first fixture element and the one end may be secured to the first planet carrier. The second fixture element may be secured relative to the first fixture element at the other end, e.g., using nuts. The second fixture element may thus be released, e.g., by removal of the nuts, so that it may move axially relative to the first fixture element. This allows the first planet carrier to move axially between the retracted and extended positions.

In one embodiment, at least one of the first and second fixture elements is accessible from an exterior of the gearbox and configured to be removed and/or inserted from the exterior.

The first fixture element and/or the second fixture element may be accessible from the exterior of the gearbox, preferably via dedicated mounting points in the gearbox housing. This allows for an easy removal and insertion of the respective fixture elements.

The first fixture element and/or the second fixture element may be removed and/or inserted using an external tool or by hands. Optionally, the first and second fixture elements may be removed and/or inserted as a pair and then secured to the first planet carrier and the other gearbox part, respectively.

One object of the present invention is achieved by a wind turbine, comprising a wind turbine tower, a nacelle arranged on top of the wind turbine tower, and a rotor with at least one wind turbine blade arranged relative to the nacelle, the rotor being connected to a drivetrain in the wind turbine, the drivetrain comprising at least a main shaft connected to a gearbox with at least one gear stage, wherein the main shaft and gearbox are assembled according to the abovementioned method.

This provides a wind turbine where the main shaft unit and the gearbox unit can be assembled using the abovementioned method. Disassembly of the main shaft unit and the gearbox unit can be done in a reversed order. This allows for the assembly and/or disassembly to be performed onsite, preferably onsite and up-tower, during replacement or repair. The assembly may also be performed offsite and the combined main shaft and gearbox unit may then be transported to the installation site of the wind turbine.

The main shaft unit and/or the gearbox unit may be positioned in an assembly stand during the assembly, which may comprise means for moving the main shaft unit and the gearbox unit into position relative to each other. Alternatively, a hoist or crane system may be used to move the main shaft unit and the gearbox unit into position relative to each other. Optionally, the main shaft unit or gearbox unit may be arranged in a stationary support structure while the other main shaft unit or gearbox unit may be arranged in a moveable support structure or suspended from the hoist or crane system. This allows for a controlled movement of one or both units.

In one embodiment, a first planet carrier of the gearbox comprising at least one dedicated mounting element for securing the first fixture element and the other gearbox part of the gearbox comprising at least one dedicated mounting element for securing the second fixture element.

The other gearbox part, e.g., the gearbox housing, may comprise dedicated mounting points adapted to receive the second fixture elements. Further, the first planet carrier may comprise dedicated mounting points adapted to receive the first fixture elements. The number of dedicated mounting points may depend on the configuration of the first gear stage. The mounting points may be formed during the manufacture of the other gearbox part and/or the first planet carrier. Alternatively, the mounting points may be machined into the other gearbox part and/or the first planet carrier.

The mounting points may preferably be located so that the first and second fixture elements may be inserted and removed from the exterior of the gearbox. This allows for easy access to the fixture elements during mounting or demounting.

### DESCRIPTION OF THE DRAWING

The present invention is described by example only and with reference to the drawings, wherein:

FIG. 1 shows an exemplary embodiment of a wind turbine,

FIG. 2 shows an exemplary embodiment of an assembly kit according to the present invention,

FIG. 3 shows a planet carrier with first fixture elements secured to dedicated mounting points,

FIG. 4 shows a gearbox housing with second fixture elements secured to dedicated mounting points,

FIG. 5 shows a first step of pre-assembling the gearbox in a vertical position,

FIG. 6 shows a second step of pre-assembling the gearbox in the vertical position,

FIG. 7 shows a first step of assembling the main shaft and the gearbox, where the pre-assembled gearbox is turned into a horizontal position,

FIG. 8 shows a second step of assembling the main shaft and the gearbox in the horizontal position,

FIG. 9 shows a third step of assembling the main shaft and the gearbox in the horizontal position,

FIG. 10 shows a fourth step of assembling the main shaft and the gearbox in the horizontal position, and

FIG. 11 shows a fifth step of assembling the main shaft and the gearbox in the horizontal position.

In the following text, the figures will be described one by one, and the different parts and positions seen in the figures will be numbered with the same numbers in the different figures. Not all parts and positions indicated in a specific figure will necessarily be discussed together with that figure.

### DETAILED DESCRIPTION OF THE INVENTION

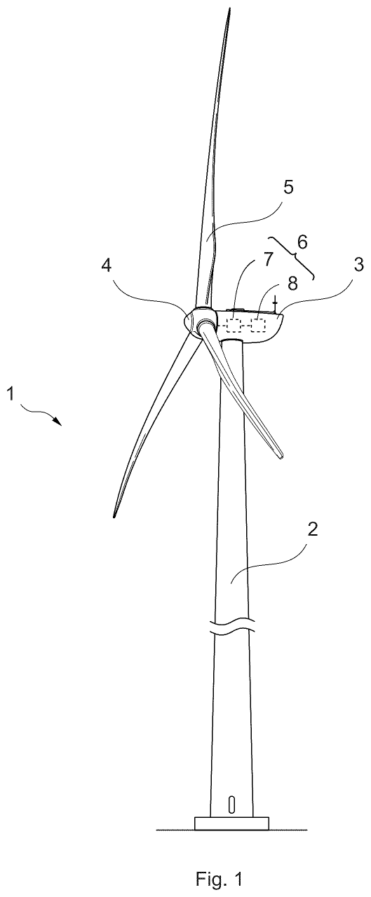

FIG. 1 shows an exemplary embodiment of a wind turbine 1 comprising a wind turbine tower 2, a nacelle 3 arranged on top of the wind turbine tower 2, and a rotor connected to a drive train in the nacelle 3. The rotor comprises a hub 4 and at least one wind turbine blade 5 connected to the hub 4. Here, three wind turbine blades 5 are shown, but the hub 5 may be connected to two, four or more wind turbine blades.

The wind turbine 1 is here shown as an onshore wind turbine, but the wind turbine 1 may also be an offshore wind turbine 1.

A drivetrain 6 of the wind turbine 1 is mechanically connected to the rotor. Here, the hub 4 is mechanically connected to an input interface of a gearbox 7 for transferring torque to the gear stages of the gearbox 7. Particularly, the hub 4 may be connected directly to the gearbox input via a bolted connection or a shaft connection.

An output interface of the gearbox 7 is mechanically connected to a rotor of a generator 8. The generator 8 further comprises a generator stator arranged relative to the generator rotor, each of which comprises a plurality of pole units configured to interact with each other via at least one magnetic field. Rotation of the generator rotor relative to the generator stator generates an electrical output current in the generator 8.

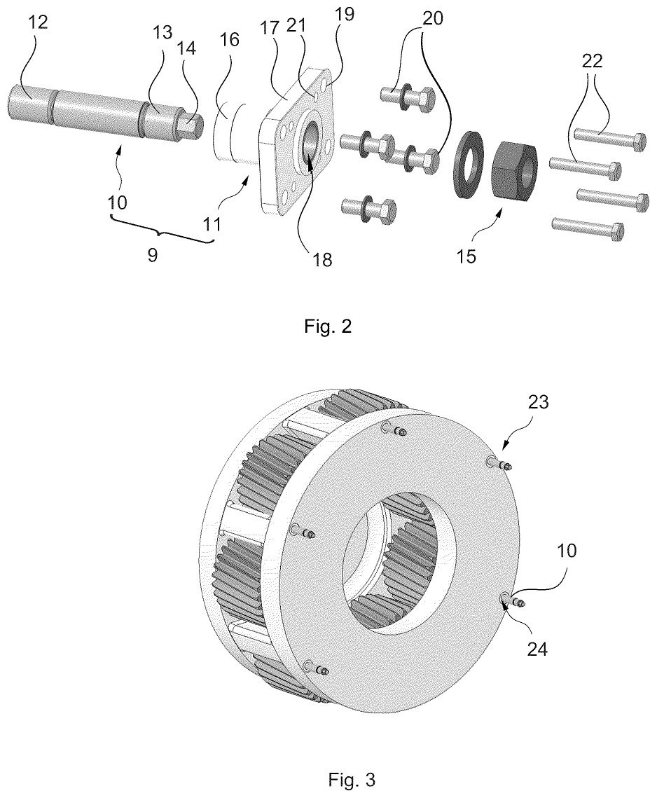

FIG. 2 shows an exemplary embodiment of an assembly kit according to the present invention. The assembly kit comprises one or more pairs of temporary fixtures 9 for fixing a first planet carrier of the gearbox relative to another gearbox part, e.g., the gearbox housing.

Each pair of temporary fixtures 9 comprises a first fixture element 10 shaped to engage a second fixture element 11. Here, the first fixture element 10 is shaped as a rod with a first end 12 and an opposite second end 13. The second end 13 has a threated portion shaped to engage a opposite threated portion of a nut 15. Further, the second end 13 has a bolt head 14 for rotating the first fixture element 10.

Here, the second fixture element 11 is shaped as a bushing with a through-hole 18 extending from a first end 16 to a second end 17. The second end 17 of the second fixture element 11 is shaped as a flange.

A plurality of first holes 19 is arranged in the flange for receiving first fasteners 20, wherein the first fasteners 20 are used to secure the second fixture element 11 to the other gearbox part. A plurality of second holes 21 is further arranged in the flange for receiving second fasteners 22, wherein the second fasteners 22 are used to remove the second fixture element 11 from the other gearbox part.

FIG. 3 shows a first planet carrier 23 of the input gear stage (ref. first gear stage) with dedicated mounting points 24 for securing the first fixture elements 10. The mounting points 24 are shaped to receive and engage the first ends 12 of the first fixture elements 10. The mounting point 24 and the first end 12 together form a threaded or a press-fit connection.

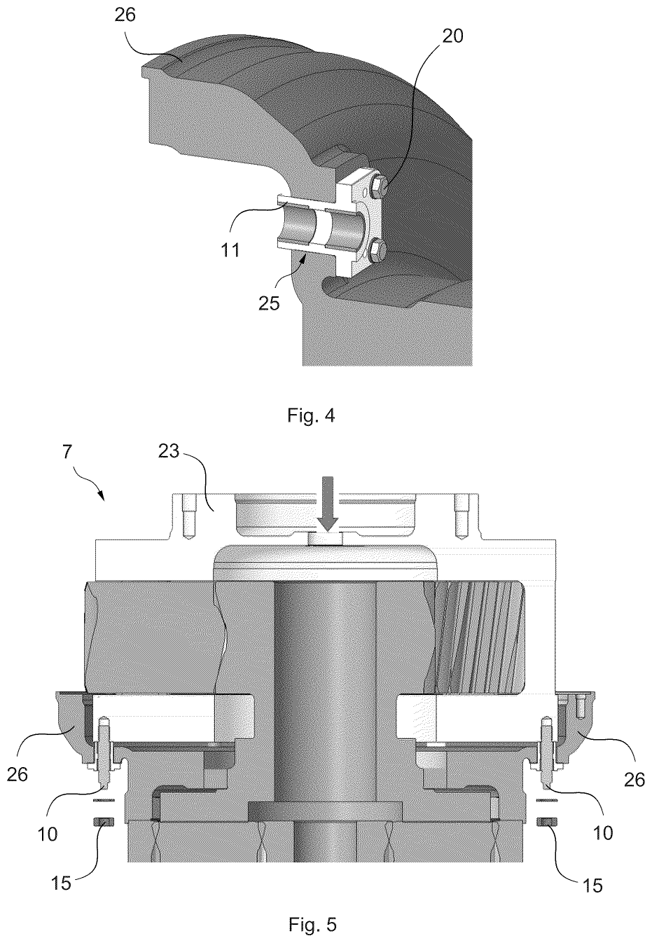

FIG. 4 shows a gearbox housing part 26 with dedicated mounting points 25 for securing the second fixture elements 11. The second fixture element 11 is secured to the gearbox housing part 26 by the second fasteners 20.

The dedicated mounting points 25 differ from the main mounting points for mounting the next gear stage. These main mounting points may be arranged in a row extending in a circumference direction.

FIG. 5 shows a first step of pre-assembling the gearbox 7 in a vertical position. The gear components and gearbox housing part of an output gear stage of the gearbox 7 are assembled using a gearbox assembly frame or table (not shown). Subsequently, the gear components and gearbox housing part of an intermediate gear stage 30 of the gearbox 7 are assembled and interconnected with the preceding gear stage. This process is repeated for each intermediate gear stage.

A gearbox housing part 26 of the input gear stage 29 is positioned and interconnected to the gearbox housing part of the preceding gear stage 30. Here, the ring gear and gearbox housing part of the preceding gear stage are interconnected to the gearbox housing 26 by a plurality of fasteners secured to the main mounting points.

The second fixture elements 11 may be secured to the gearbox housing part 26 before or after the gearbox housing part 26 is installed.

The input planet carrier (ref. first planet carrier) 23, the sun gear and the sun shaft of the input gear stage 29 are assembled and positioned on the gearbox housing part 26. The first planet carrier 23 are then rotated to align the second fixture elements 11 with the dedicated mounting points 24. The first fixture elements 10 are then inserted and secured to the first planet carrier 23 to prevent movement in the radial direction. The nuts 15 are then secured to the first fixture elements 10 to prevent movement in the axial direction. The first planet carrier 23 is thereby fixed in a retracted position.

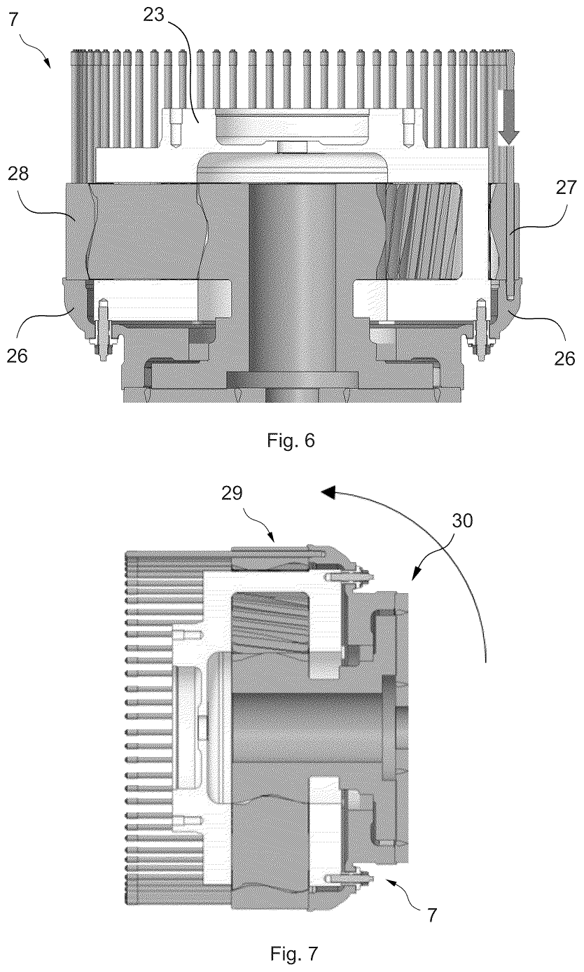

FIG. 6 shows a second step of pre-assembling the gearbox 7 in the vertical position. An input ring gear (ref. first ring gear) 28 is slid into position relative to the sun gears and the gearbox housing part 26. A plurality of first fastener elements 27 are inserted into mounting holes on the first ring gear 28 and secured to the gearbox housing part 26.

The first ring gear 28 may optionally be temporarily fixed to prevent axial movement during the assembly of a main shaft and the gearbox 7.

FIG. 7 shows a first step of assembling the main shaft and the gearbox 7, where the pre-assembled gearbox 7 is turned into a horizontal position. The main shaft is further turned into the horizontal position.

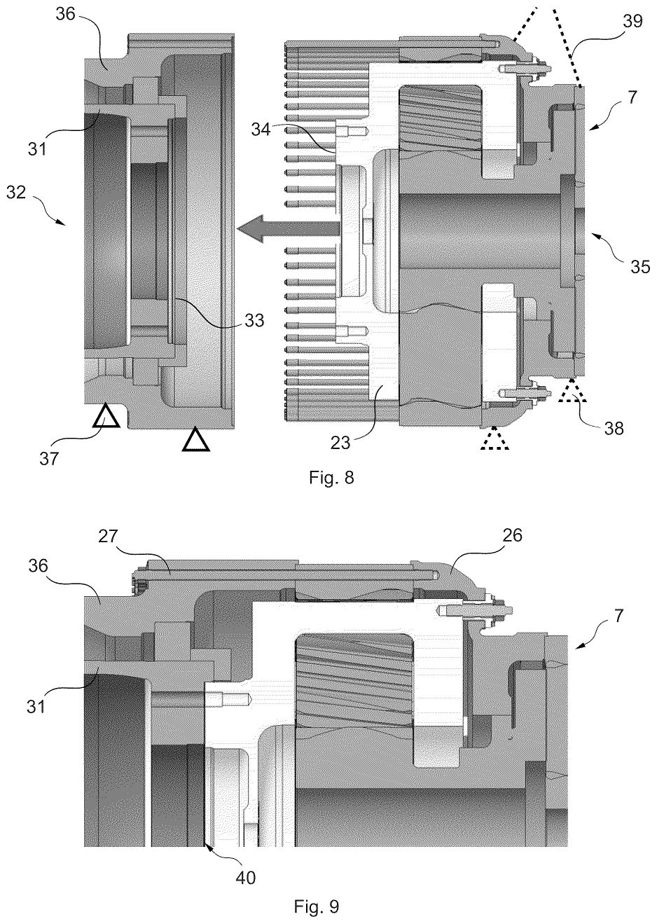

FIG. 8 shows a second step of assembling the main shaft 31 and the gearbox 7 in the horizontal position. The main shaft 31 has a rotor end 32 and a gearbox end 32. The gearbox 7 has a main shaft end 34 and a generator end 35.

The main shaft 31 unit and the gearbox 7 unit are aligned relative to each other. The main shaft end 34 of the gearbox 7 and the gearbox end 33 of the main shaft 31 are moved towards each other until they are in position relative to each other.

Here, the main shaft 31 is enclosed by a main bearing housing 36, which is resting on a set of stationary supports 37. The gearbox 7 is suspended by a crane wire 39 connected to a crane unit (not shown) for moving the gearbox 7 into position relative to the main shaft 31. Alternatively, the gearbox 7 may rest on a set of moveable supports 38 for moving the gearbox 7 into position relative to the main shaft 31.

FIG. 9 shows a third step of assembling the main shaft 31 and the gearbox 7 in the horizontal position. When moved into position, the gearbox housing part 26 and the ring gear 28 is connected to the main bearing housing 36 by securing the first fastener elements 27 to the main bearing housing 36.

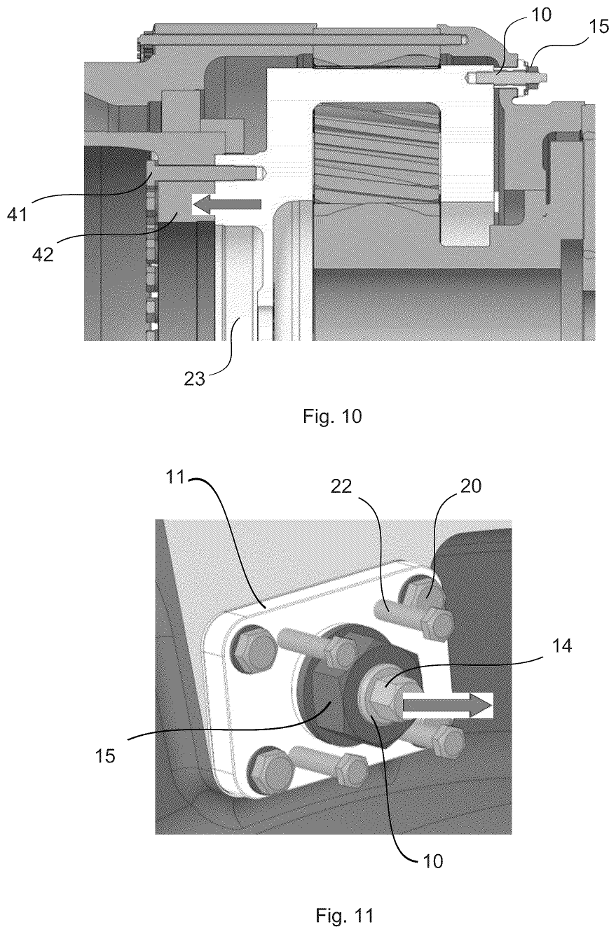

FIG. 10 shows a fourth step of assembling the main shaft 31 and the gearbox 7 in the horizontal position. Second fastener elements 41 are inserted through main mounting holes in a flange 42 of the main shaft 31. The second fastener elements 41 are loosely secured to main mounting points in the main shaft end 34. The nuts 15 are loosened, or removed, and the second fastener elements 41 are tightened. This causes the first planet carrier 23 to move axially from the retracted position to an extended position. In the extended position, the main shaft end 34 contacts the gearbox end 33.

FIG. 11 shows a fifth and final step of assembling the main shaft 31 and the gearbox 7 in the horizontal position. When the main shaft end 34 and the gearbox end 33 are connected to each other by the second fastener elements 41, any remaining nuts 15 are removed.

The first fixture elements 10 are loosened and removed by engaging the bolt head 14 with a tool. The first fastener elements 20 are further loosened and removed. The second fixture elements 11 are finally removed by applying a pulling force to the second fastener elements 22.

1. A method of assembling a drivetrain (6) for a wind turbine (1), the drivetrain (6) comprising at least a main shaft (31) unit and a gearbox (7) unit with at least one gear stage, where the method comprises the steps of:
providing a main shaft (31) having a rotor end (32) and a gearbox end (33),
providing a gearbox (7) having a main shaft end (34) and a generator end (35),
aligning the main shaft (31) unit and the gearbox (7) unit relative to each other,
moving the main shaft end (34) of the gearbox (7) and the gearbox end (33) of the main shaft (31) into position relative to each other,
connecting the main shaft (31) unit to the gearbox (7) unit,
wherein when moved into position, a first planet carrier (23) of the gearbox (7) is further moved axially from a retracted position into an extended position, in which the first planet carrier (23) is connected to a flange (42) of the main shaft (31) at the gearbox end (33).

2. The method according to claim 1, wherein the first planet carrier (23) is fixed relative to another gearbox part, preferably a gearbox housing (26), prior to moving the gearbox (7) unit and the main shaft (31) unit into position.

3. The method according to claim 2, wherein the first planet carrier (23) is fixed to the other gearbox part by mounting a number of temporary fixtures (9) to the first planet carrier (23) and to the other gearbox part.

4. The method according to claim 3, wherein at least one first fixture element (10) is mounted to the first planet carrier (23) and at least one second fixture element (11) is mounted to the other gearbox part, where the first planet carrier (23) is fixed relative to the other gearbox part by bringing the first and second fixture elements (10, 11) into engagement to form at least one pair of temporary fixtures (9).

5. The method according to claim 1, wherein when moved into position, a gearbox housing (26) of the gearbox (7) is secured to a main bearing housing (36) by first fastener elements (27).

6. The method according to claim 1, wherein second fastener elements (41) are inserted into the flange (42) and at least partly secured to the first planet carrier (23), where the first planet carrier (23) is moved axially by tightening the second fastener elements (41).

7. The method according to claim 1, wherein the method further comprises the step of pre-assembling the respective gear stages of the gearbox (7) in a vertical direction.

8. The method according to claim 1, wherein a first ring gear (28) of the gearbox (7) is fixed relative to the gearbox housing (26) before moving the main shaft end (34) and the gearbox end (33) into position.

9. The method according to claim 1, wherein the main shaft (31) and the gearbox (7) are assembled and/or disassembled onsite and up-tower, wherein the gearbox (7) is optionally pre-assembled at another location.

10. An assembly kit for use in assembling a drivetrain for a wind turbine according to claim 1, comprising:
at least one first fixture element (10) configured to be mounted to a first planet carrier (23) of the gearbox (7),
at least one second fixture element (11) configured to be mounted to another gearbox part, preferably a gearbox housing (26),
wherein the first fixture element (10) is shaped to engage the second fixture element (11) to form at least one pair of temporary fixtures (9) for fixing the first planet carrier (23) relative to the other gearbox part.

11. The assembly kit according to claim 10, wherein the first fixture element (10) is a rod with a first end (12) and an opposite second end (13), the first end (12) being configured to be secured to a mounting point (24) on the first planet carrier (23).

12. The assembly kit according to claim 10, wherein the second fixture element (11) is a bushing with a hole (18), a first end (16) and an opposite second end (17), the second end (17) being configured to be secured to a mounting point (25) on the other gearbox part.

13. The assembly kit according to claim 11, wherein at least one of the first and second fixture elements (10, 11) is accessible from an exterior of the gearbox (7) and configured to be removed and/or inserted from the exterior.

14. A wind turbine comprising a wind turbine tower (2), a nacelle (3) arranged on top of the wind turbine tower (2), and a rotor with at least one wind turbine blade (5) arranged relative to the nacelle (3), the rotor being connected to a drivetrain (6) in the wind turbine (1), the drivetrain (6) comprising at least a main shaft (31) connected to a gearbox (7) with at least one gear stage, wherein the main shaft (31) and gearbox (7) are assembled according to the method of any one of claims 1 to 9.

15. The wind turbine according to claim 14, wherein a first planet carrier (23) of the gearbox (7) comprising at least one dedicated mounting element (24) for securing the first fixture element (10) and the other gearbox part of the gearbox (7) comprising at least one dedicated mounting element (25) for securing the second fixture element (11).
